(19) United States
(12) Patent Application Publication
(10) Pub. No.: US 2023/0008839 A1
(43) Pub. Date: Jan. 12, 2023

(54) SMART ENVIRONMENT ASSESSMENT OF PREREQUISITES TO PRIVATE CLOUD PROVISIONING

(71) Applicant: Red Hat, Inc., Raleigh, NC (US)

(72) Inventors: William Henry, Denver, CO (US); Lester Claudio, Denver, CO (US)

(21) Appl. No.: 17/373,662

(22) Filed: Jul. 12, 2021

(51) Int. Cl. G06F 11/36; G06F 16/955; G06F 8/61; G06F 8/65

(52) U.S. Cl. CPC G06F 11/3604; G06F 16/955; G06F 8/61; G06F 8/65

(57) ABSTRACT

Systems and methods for performing a complete assessment of a disconnected environment to determine if any prerequisite components (dependencies) necessary for the installation of cloud infrastructure are missing from the disconnected environment and generating a report based on the assessment are provided. An offline bundle having an assessment playbook may be imported into the disconnected environment. The assessment playbook may determine whether the disconnected environment includes each of a set of prerequisite components of the cloud infrastructure and generate a report indicating one or more of the set of prerequisite components that are missing from the disconnected environment. An automation playbook may be generated based on the report, wherein the automation playbook installs each of the one or more of the set of prerequisite components that are missing from the disconnected environment.

### TECHNICAL FIELD

Aspects of the present disclosure relate to disconnected environments, and more particularly, to installing cloud infrastructure within a disconnected environment.

### BACKGROUND

A disconnected environment is one where a connection to outside systems via the internet or any other communication medium is non-existent or limited. In a disconnected environment, access to many intranet services can also be restricted. Such disconnected environments can be systems where the nature of information and/or technology capabilities available require a high degree of security, such as high security government systems.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram that illustrates an example system, in accordance with some embodiments of the present disclosure.

FIG. 1B is a block diagram that illustrates an example system, in accordance with some embodiments of the present disclosure.

FIG. 2A is a block diagram that illustrates an example system, in accordance with some embodiments of the present disclosure.

FIG. 2B is a block diagram that illustrates an example system, in accordance with some embodiments of the present disclosure.

FIG. 3 illustrates a tree diagram of the functionality of an assessment playbook, in accordance with some embodiments of the present disclosure.

FIG. 4 is a flow diagram of a method for assessing a disconnected environment and generating a report detailing prerequisite components of cloud infrastructure that are missing from the disconnected environment, in accordance with some embodiments of the present disclosure.

FIG. 5 is a flow diagram of a method for generating an automation playbook based on the report generated by the method of FIG. 4, in accordance with some embodiments of the present disclosure.

FIG. 6 is a block diagram of an example computing device that may perform one or more of the operations described herein, in accordance with some embodiments of the present disclosure.

### DETAILED DESCRIPTION

When installing cloud infrastructure, there are often a number of prerequisite available services (also referred to herein as dependencies or prerequisite components) that must be installed in order to install and deploy the cloud infrastructure. Such dependencies are usually resolved easily if an internet or similar connection is available to obtain such prerequisite services. However, installing and deploying software on disconnected environments can present challenges owing to availability of dependencies within the disconnected environment, a lack of skills, knowledge, and/or access to those dependencies, and red tape involved in navigating access to those dependencies as well as procuring skills relevant to those dependencies. In addition, many of these prerequisites are often not owned by the client or the vendor, making access to them without a connection to outside systems difficult.

This can cause numerous business disruptions within a disconnected environment. For example, the inability to procure prerequisite components can delay the deployment of cloud infrastructure software by a significant time frame, delay revenue recognition for consulting and other services, delay or inhibit the sale of further products of the vendor to the client (e.g., application services and/or middleware), and result in acute client dissatisfaction which can result in cancellation of services etc.

The present disclosure addresses the above-noted and other deficiencies by using a processing device to perform a complete assessment of a disconnected environment to determine which prerequisite components (dependencies) necessary for the installation of cloud infrastructure are missing from the disconnected environment. The processing device may import an offline bundle into the disconnected environment, wherein the offline bundle comprises an assessment playbook for performing the assessment. The processing device may determine initial environment information, perform the assessment, and generate (using the assessment playbook) a report providing information about each of the missing prerequisite components and any additional environment information pertinent thereto. The processing device may also generate, based on the report, an automation playbook for installing and deploying the missing prerequisite components. For each missing prerequisite component, the automation playbook may include a callout to an installation playbook corresponding to the missing prerequisite component. The offline bundle may include a set of installation playbooks, each installation playbook providing functionality to install and deploy a particular prerequisite component. It should be noted that the techniques described herein are not limited to installation of simple software on a single machine, but may apply to complex cloud infrastructures deployed across multiple machines. No third party tools are relied on for the assessment of the disconnected environment or the generation of the report or the automation playbook.

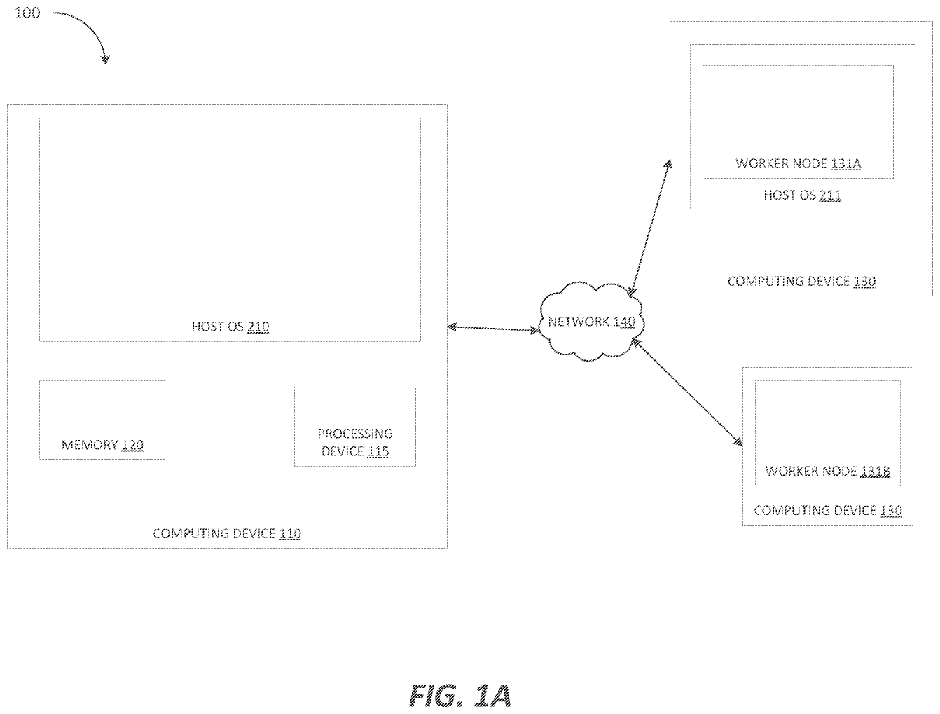

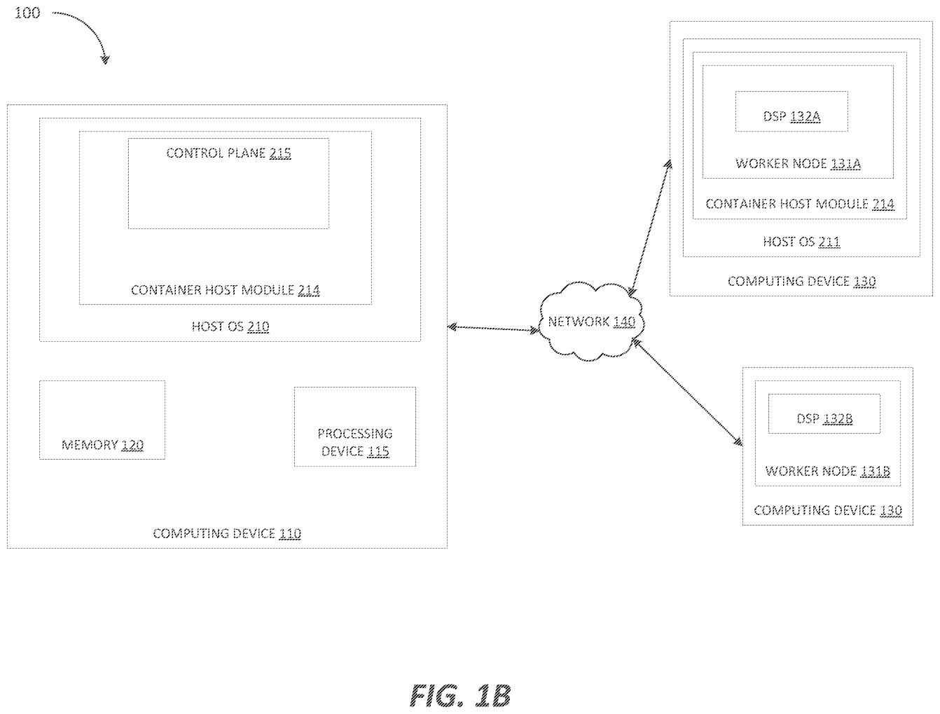

FIG. 1 is a block diagram that illustrates an example system 100 which may be a disconnected environment on which cloud infrastructure such as a container orchestration engine is to be installed. As illustrated in FIG. 1, the system 100 includes a computing device 110, and a plurality of computing devices 130. The computing devices 110 and 130 may be coupled to each other (e.g., may be operatively coupled, communicatively coupled, may communicate data/messages with each other) via network 140. Because system 100 is a disconnected environment, network 140 may be a private network (e.g., a local area network (LAN) or wide area network (WAN)) implemented using a wired or a wireless infrastructure. For example, the network 140 may be implemented using one or more wireless communications systems, such as a WiFi′ hotspot connected with the network 140. In some embodiments, the network 140 may be an L3 network. The network 140 may carry communications (e.g., data, message, packets, frames, etc.) between computing device 110 and computing devices 130. As discussed herein, the system 100 may lack (or have limited access to) any connection to outside systems, via the internet or any other communication medium.

Each computing device 110 and 130 may include hardware such as processing device 115 (e.g., processors, central processing units (CPUs)), memory 120 (e.g., random access memory 120 (e.g., RAM)), storage devices (e.g., hard-disk drive (HDD), solid-state drive (SSD), etc.—not shown), and other hardware devices (e.g., sound card, video card, etc.—not shown). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as host OS 210 and host OS 211 respectively, as discussed in more detail below. The host OS of a computing device 110 or 130 may manage the execution of other components (e.g., software, applications, etc.) and/or may manage access to the hardware (e.g., processors, memory, storage devices etc.) of the computing device.

FIG. 1B illustrates the system 100 when a container orchestration engine 214 (one example of cloud infrastructure) has been installed thereon. The container orchestration engine 214 (referred to herein as container host 214) may execute on the host OS 210 of computing device 110 and the host OS 211 of computing devices 130, as discussed in further detail herein. The container host 214 may be a platform for developing and running containerized applications (such as e.g., the Redhat™ OpenShift™ platform) and may allow applications and the data centers that support it to expand from just a few machines and applications to thousands of machines that serve millions of clients. Container host 214 may provide an image-based deployment module for creating containers and may store one or more image files for creating container instances. Many application instances can be running in containers on a single host without visibility into each other's processes, files, network, and so on. Each container may provide a single function (often called a “micro-service”) or component of an application, such as a web server or a database, though containers can be used for arbitrary workloads. In this way, the container host 214 provides a function-based architecture of smaller, decoupled units that work together.

A typical deployment of the container host 214 may include a control plane 215 (e.g., as part of a container orchestration engine) and a cluster of worker nodes 131, including worker nodes 131A and 131B (also referred to as compute machines). The control plane 215 may include REST APIs which expose objects as well as controllers which read those APIs, apply changes to objects, and report status or write back to objects. The control plane 215 manages workloads on the worker nodes 131 and also executes services that are required to control the worker nodes 131. By nature, containerized applications are separated from specific operating system distributions where they run and, by extension, their users. For example, on the Linux™ container platform, the container relies only on the kernel and nothing above that kernel layer, which includes specific Linux distribution information and users on the system. The control plane 215 may expose applications to internal and external networks by defining network policies that control communication with containerized applications (e.g., incoming HTTP or HTTPS requests for services inside the cluster).

The cluster of worker nodes 131 are where the actual workloads requested by users run and are managed. The worker nodes 131 advertise their capacity and a scheduler (not shown), which is part of the control plane 215, determines which worker nodes 131 containers and pods will be started on. Each worker node 131 includes functionality to accept and fulfill requests for running and stopping container workloads, and a service proxy, which manages communication for pods across worker nodes 131. A worker node 131 may be implemented as a virtual server, logical container, or GPU, for example.

It follows based on the above discussion that cloud infrastructure such as the container host 214 may depend on numerous prerequisite components that must exist within the system 100 before it can be installed. Because system 100 is a disconnected environment, it may lack an appropriate means by which prerequisite components needed to install the container host 214 can be procured. However, system 100 may provide a secure means for allowing boundary access from e.g., a secure external system or device of the client (not shown) that is located in physical proximity to the system 100 via computing device 110. Using the secure means, content can be brought into the system 100 on a limited basis in order to start assessing the system 100 and installing/providing various prerequisite components as discussed in further detail herein. For example, a vendor may generate the content and bring it physically to the client where it may be transferred to and verified by a secure system or device of the client external to the system 100. The system 100 may support the use of an encrypted link such as a virtual private network (VPN) tunnel or other appropriate secure communication channel between computing device 110 and the secure client system or device on which the content may be located. Although embodiments of the present disclosure are discussed with respect to installation of a container host for description and example purposes, the present disclosure is not limited in this way and the embodiments described herein may be applied to installation of any appropriate cloud infrastructure software in a disconnected environment.

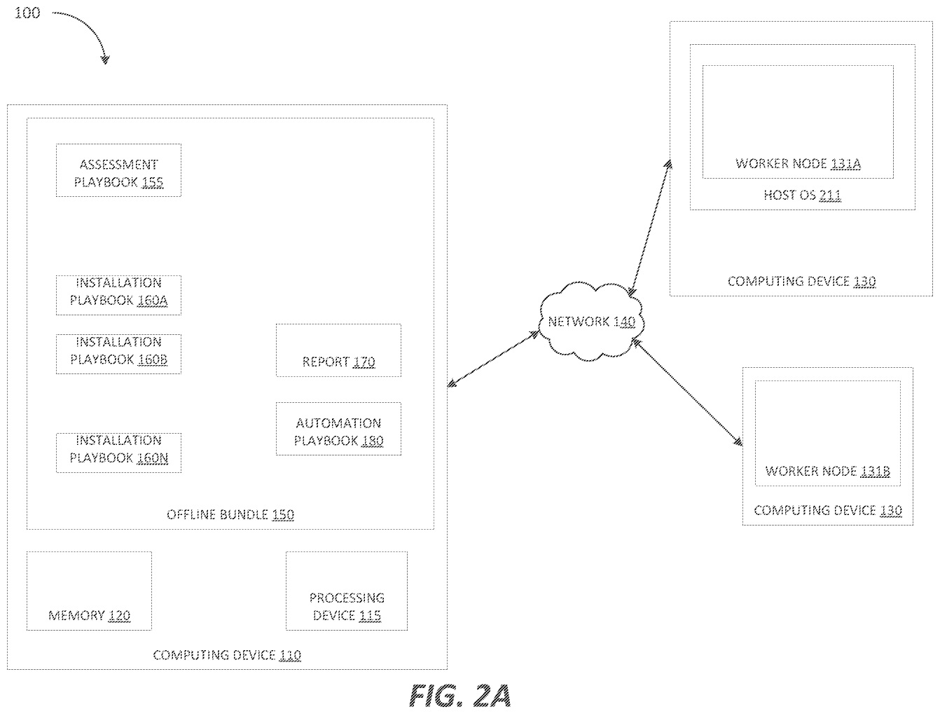

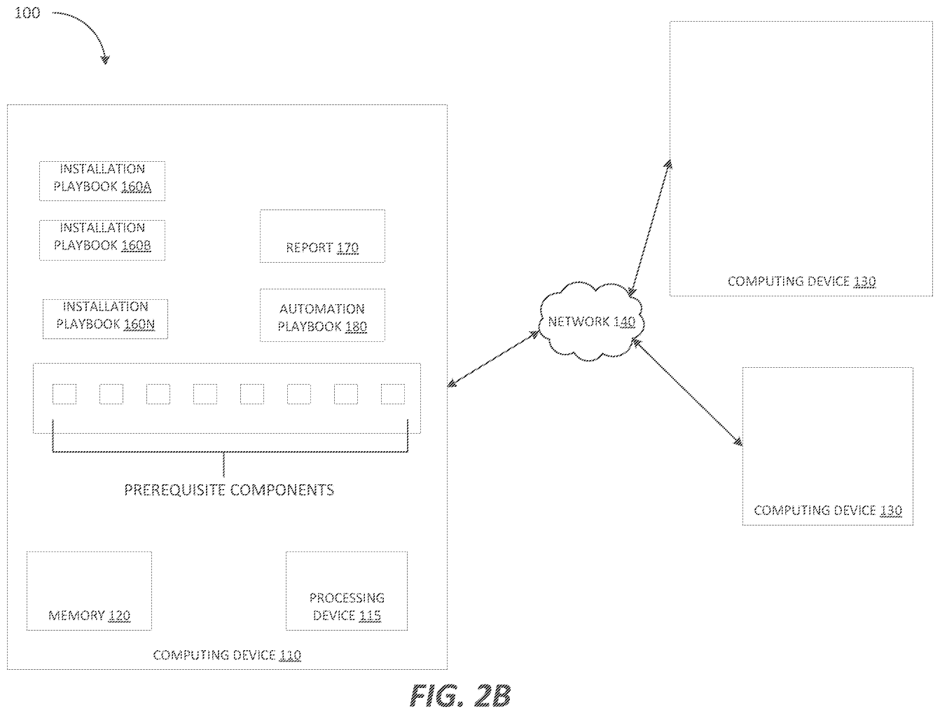

Referring to FIGS. 2A and 2B, in order to install the container host, a client operating the system 100 may import an offline bundle 150 (e.g., the vendor content) from a secure client system or device outside of system 100 as discussed above. The offline bundle 150 may comprise a data file that includes within it an assessment playbook 155, a set of installation playbooks 160, and various other images (e.g., container host images, core operating system images—not shown), executables (e.g., container host install executable—not shown), and binaries. A playbook may comprise prewritten code/scripts (usable on an ad-hoc basis or as starting template) that can act as a blueprint of an automation task, which may be a complex information technology (IT) action executed with limited or no human involvement. One example of a playbook may be an Ansible™ playbook, which may provide a stateful method for automating IT actions. Playbooks can declare configurations, orchestrate steps of any manual ordered process on multiple sets of machines in a defined order, and launch tasks synchronously or asynchronously. Playbooks can be used to automate IT infrastructure (such as operating systems and Kubernetes platforms), networks, and security systems, among others. Playbooks may be executed on a set, group, or classification of hosts, and may offer a repeatable, re-usable, simple configuration management and multi-machine deployment system that is well suited to deploying complex applications. It should be noted that although described with respect to Ansible playbooks, the embodiments of the present disclosure are not limited in this way and the assessment playbook 155 as well as each installation playbook may comprise any appropriate type of automation script.

The assessment playbook 155 may include a list of prerequisite components necessary for generation of the container host that it will check for the existence of, and functionality for checking for the existence of each prerequisite component. The functionality for performing each of these checks may be implemented as a role in the assessment playbook 155, and each role may run a command that tests for the existence of the corresponding prerequisite component. Because the assessment playbook 155 is providing an assessment for installation of cloud infrastructure across multiple machines (and not just installation of software on a single machine), it may perform checks for a variety of prerequisite component types including services, middleware services, and infrastructure services, for example. Example prerequisite components that the assessment playbook 155 may check for include storage requirements, a DHCP service, a DNS service, an image registry, an object storage, a package manager, an ignition webhost (e.g., an HTTP server such as Apache™ server or NGINX™ server) that will act as a bootstrap machine and dynamically serve HTTP content, network and application load balancers, and various required packages etc. For example, to check for the existence of a DNS service, the assessment playbook 155 may perform a name server (NS) lookup. If the NS lookup is unsuccessful, the assessment playbook 155 may determine that the DNS service is missing/non-existent. By having a defined list of prerequisite components that the assessment playbook 155 checks for whenever installing cloud infrastructure, embodiments of the present disclosure ensure consistency across cloud infrastructure installations.

In some embodiments, prior to checking for the existence of prerequisite components, the assessment playbook 155 may perform an initial check for environment information (also referred to as domain specific information) of the system 100, which may be used by the assessment playbook 155 as input variables when checking for the existence of the various prerequisite components. The environment information (not shown) may include information about the actual devices on the system 100 which will be communicating with the services, middleware services, and infrastructure services necessary for implementation of the container host. Examples of environment information may include subnet information such as IP addresses and names of devices within the system 100 (e.g., in order to make contact with them) as well as device designations (e.g., worker node, master node etc.). The assessment playbook 155 may also check to determine that the computing device 110 (on which the assessment playbook 155 is executing) has access permissions for those devices and that the assessment playbook is running as the root user on computing device 110.

Upon start-up, the assessment playbook 155 may also generate a report 170 for documenting missing prerequisite components. The report 170 may initially be empty upon generation, but as the assessment playbook 155 checks for each prerequisite component and determines missing prerequisite components, it may include information about those missing prerequisite components within the report 170. For example, if the assessment playbook 155 determines that a prerequisite component is missing (e.g., missing DNS service based on an unsuccessful NS lookup), it may generate an entry in the report 170 indicating the name and details of the missing prerequisite component, a short description of why the missing prerequisite component is required, a location within the offline bundle 150 where an installation playbook 160 corresponding to the missing prerequisite component may be located, and a reference to a uniform resource locator (URL) link to supporting documentation for the prerequisite component. It should be noted that the link cannot be used internally within the system 100 unless the supporting documentation has been moved within the system 100.

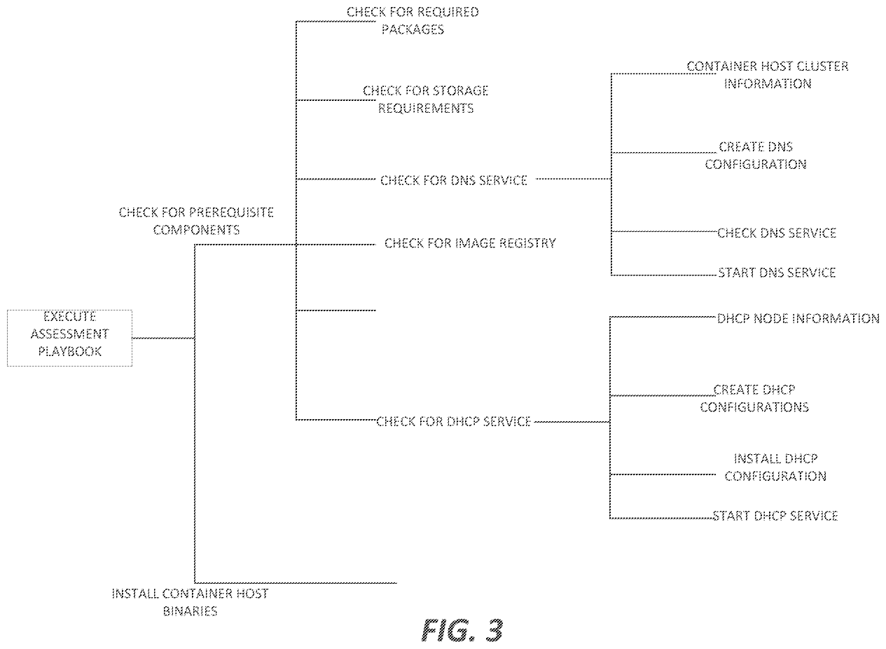

After the assessment playbook 155 performs checks to determine whether each of the prerequisite components exists or not, it may also determine additional environment information that is required for each of the prerequisite components. The additional environment information may correspond to environment information that is to be generated by each of the prerequisite components (as discussed in further detail with respect to FIG. 3). The assessment playbook 155 may add the additional environment information to the report 170.

FIG. 3 illustrates a tree diagram of the assessment playbook 115's functionality, including check for the existence of prerequisite components necessary for the container host to be installed on the system 100 as well as the additional environment information pertinent to some of those prerequisite components. The offline bundle 150 may be imported into the system 100 as discussed in further detail herein and once the offline bundle 150 is deployed and assessment playbook 155 is executed, it may check for the initial environment information as described hereinabove, proceed to check for each of the various prerequisite components, and generate the report 170 based on the result of each of the checks as described hereinabove. Upon performing the checks to determine whether each of the prerequisite components exists or not, the assessment playbook 155 may determine the additional environment information. For example, if the assessment playbook 155 detects a DNS service, it may look at the corresponding DNS entries and determine container host cluster information (e.g., how many devices are on the subnet), as well as create DNS configurations for each of those devices (e.g., IP address, device name, device designation e.g., worker node, master node etc.). Similarly, if the assessment playbook 155 detects a DHCP service, it may look at the DHCP node information and create DHCP configurations for each of those DHCP nodes. This additional environment information may be added to the report 170 for use when the prerequisite components are to be installed. By determining the additional environment information after the checks are performed, an administrator/consultant/installer of the client may have an opportunity to approve the prerequisite components to be installed and check the automation playbook 180, if required. This is also useful in scenarios where environment variables information pertinent to one remediation step could be useful in a future remediation step.

Referring back to FIGS. 2A and 2B, the offline bundle 150 may further include a set of install playbooks 160, each of which may function to install a particular prerequisite component. As the assessment playbook 155 determines which prerequisite components are missing and generates the report 170, it may simultaneously build an automation playbook 180 using install playbooks 160 that correspond to the missing prerequisite components. For example, in response to determining that the DHCP service is missing, the assessment playbook 155 may add to the automation playbook 180, a call to the install playbook 160A, which may function to install the DHCP service.

In some embodiments, the automation playbook 180 may also include information on where installation and deployment content for various dependencies is located. For example, in response to determining that the system 100 includes a package repository/package installer, the automation playbook 180 may indicate that the package repository is to be searched for particular missing prerequisite components before a call to an installation playbook 160 corresponding to the missing prerequisite component is added to the automation playbook 180. In some embodiments, if the assessment playbook 155 determines that the package repository is missing one sub-component of a prerequisite component, it may use the appropriate install playbook 160 to install that sub-component into the package registry and then instruct the system to install the sub-component from the package registry. Because the offline bundle 150 is open source, a wide variety of playbooks, images, and executables etc. may be brought into the system 100, as well as updates to certain playbooks, images, and executables etc. Thus, although the automation playbook 180 is generated with callouts to certain installation playbooks 160, such call outs could call out to an installation playbook 160 that could change within any appropriate time period, for example.

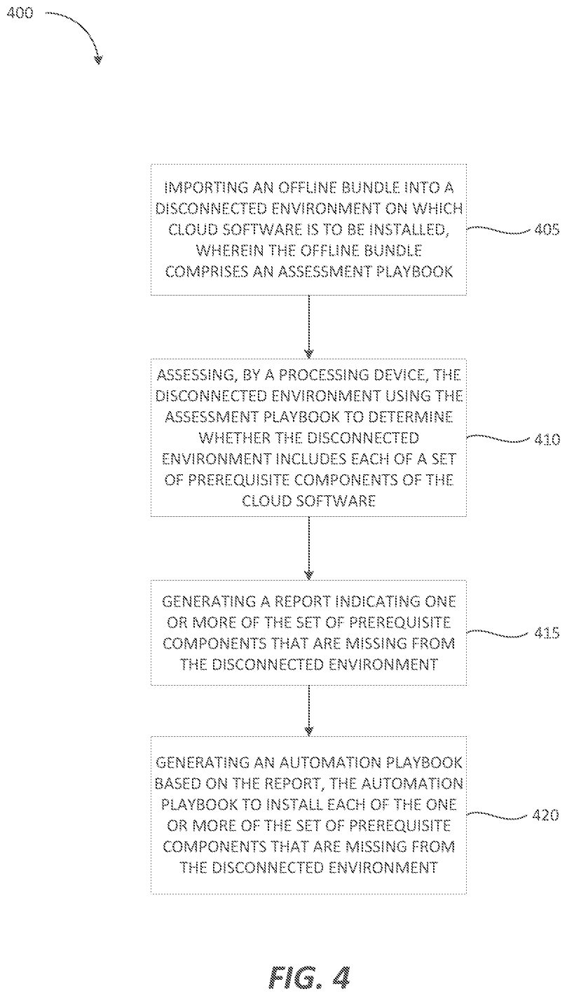

FIG. 4 is a flow diagram of a method 400 of assessing a disconnected environment and generating a report detailing prerequisite components of cloud infrastructure that are missing from the disconnected environment, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 110 executing the assessment playbook 155 as illustrated in FIG. 2).

Referring also to FIG. 2, at block 405, the computing device 110 may import an offline bundle into a disconnected environment (system 100) on which cloud software is to be installed, wherein the offline bundle comprises an assessment playbook. More specifically, a client operating the system 100 may import an offline bundle 150 (e.g., the vendor content) from a secure client system or device outside of system 100 as discussed above. The offline bundle 150 may comprise a data file that includes within it an assessment playbook 155, a set of installation playbooks 160, and various other images (e.g., container host images, core operating system images—not shown), executables (e.g., container host install executable—not shown), and binaries. A playbook may comprise prewritten code/scripts (usable on an ad-hoc basis or as starting template) that can act as a blueprint of an automation task, which may be a complex information technology (IT) action executed with limited or no human involvement.

At block 410, the computing device 110 may assess the disconnected environment using the assessment playbook to determine whether the disconnected environment includes each of a set of prerequisite components of the cloud software. The assessment playbook 155 may include a list of prerequisite components necessary for generation of the container host that it will check for the existence of, and functionality for checking for the existence of each prerequisite component. The functionality for performing each of these checks may be implemented as a role in the assessment playbook 155, and each role may run a command that tests for the existence of the corresponding prerequisite component. Because the assessment playbook 155 is providing an assessment for installation of cloud infrastructure across multiple machines (and not just installation of software on a single machine), it may perform checks for a variety of prerequisite component types including services, middleware services, and infrastructure services, for example. Example prerequisite components that the assessment playbook 155 may check for include storage requirements, a DHCP service, a DNS service, an image registry, an object storage, a package manager, an ignition webhost (e.g., an HTTP server such as Apache™ server or NGINX™ server) that will act as a bootstrap machine and dynamically serve HTTP content, network and application load balancers, and various required packages etc. For example, to check for the existence of a DNS service, the assessment playbook 155 may perform a name server (NS) lookup. If the NS lookup is unsuccessful, the assessment playbook 155 may determine that the DNS service is missing/non-existent. By having a defined list of prerequisite components that the assessment playbook 155 checks for whenever installing cloud infrastructure, embodiments of the present disclosure ensure consistency across cloud infrastructure installations.

In some embodiments, prior to checking for the existence of prerequisite components, the assessment playbook 155 may perform an initial check for environment information (also referred to as domain specific information) of the system 100, which may be used by the assessment playbook 155 as input variables when checking for the existence of the various prerequisite components. The environment information (not shown) may include information about the actual devices on the system 100 which will be communicating with the services, middleware services, and infrastructure services necessary for implementation of the container host. Examples of environment information may include subnet information such as IP addresses and names of devices within the system 100 (e.g., in order to make contact with them) as well as device designations (e.g., worker node, master node etc.). The assessment playbook 155 may also check to determine that the computing device 110 (on which the assessment playbook 155 is executing) has access permissions for those devices and that the assessment playbook is running as the root user on computing device 110.

At block 415, the computing device 110 may generate a report indicating one or more of the set of prerequisite components that are missing from the disconnected environment. Upon start-up, the assessment playbook 155 may also generate a report 170 for documenting missing prerequisite components. The report 170 may initially be empty upon generation, but as the assessment playbook 155 checks for each prerequisite component and determines missing prerequisite components, it may include information about those missing prerequisite components within the report 170. For example, if the assessment playbook 155 determines that a prerequisite component is missing (e.g., missing DNS service based on an unsuccessful NS lookup), it may generate an entry in the report 170 indicating the name and details of the missing prerequisite component, a short description of why the missing prerequisite component is required, a location within the offline bundle 150 where an installation playbook 160 corresponding to the missing prerequisite component may be located, and a reference to a uniform resource locator (URL) link to supporting documentation for the prerequisite component. It should be noted that the link cannot be used internally within the system 100 unless the supporting documentation has been moved within the system 100.

After the assessment playbook 155 performs checks to determine whether each of the prerequisite components exists or not, it may also determine additional environment information that is required for the container host to be installed on the system 100. The additional environment information may correspond to environment information that is to be generated by one or more of the prerequisite components (as discussed in further detail with respect to FIG. 3A). The assessment playbook 155 may add the additional environment information to the report 170.

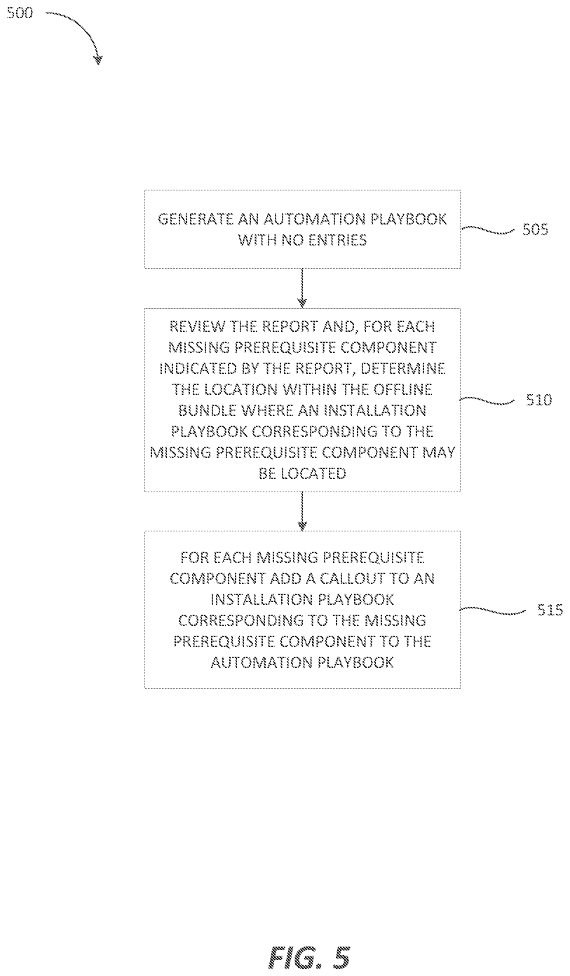

FIG. 5 is a flow diagram of a method 500 for generating an automation playbook to install and deploy each of the one or more of the set of prerequisite components that are missing from the system 100, in accordance with some embodiments of the present disclosure. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 110 executing the assessment playbook 155 as illustrated in FIG. 2).

The offline bundle 150 may further include a set of install playbooks 160, each of which may function to install a particular prerequisite component. At block 505 the computing device 110 may generate an automation playbook 180 that is currently empty. At block 510, the computing device may review the report 170, and for each missing prerequisite component indicated by the report 170, determine the location within the offline bundle 150 where an installation playbook 160 corresponding to the missing prerequisite component may be located. At block 515, for each missing prerequisite component, the computing device 110 may add a callout to an installation playbook 160 corresponding to the missing prerequisite component to the automation playbook. For example, in response to determining that the DHCP service is missing, the computing device 110 may add to the automation playbook 180, a call to the install playbook 160A, which may function to install the DHCP service.

In some embodiments, the automation playbook 180 may also include information on where installation and deployment content for various dependencies is located. For example, in response to determining that the system 100 includes a package repository/package installer, the automation playbook 180 may indicate that the package repository is to be searched for particular missing prerequisite components before a call to an installation playbook 160 corresponding to the missing prerequisite component is added to the automation playbook 180. In some embodiments, if the assessment playbook 155 determines that the package repository is missing one sub-component of a prerequisite component, it may use the appropriate install playbook 160 to install that sub-component into the package registry and then instruct the system to install the sub-component from the package registry.

In some embodiments, the automation playbook 180 may proceed to install the necessary prerequisite components automatically upon completion, instead of waiting for client approval. In other embodiments as discussed herein, the automation playbook 180 may wait for approval from the client before installing.

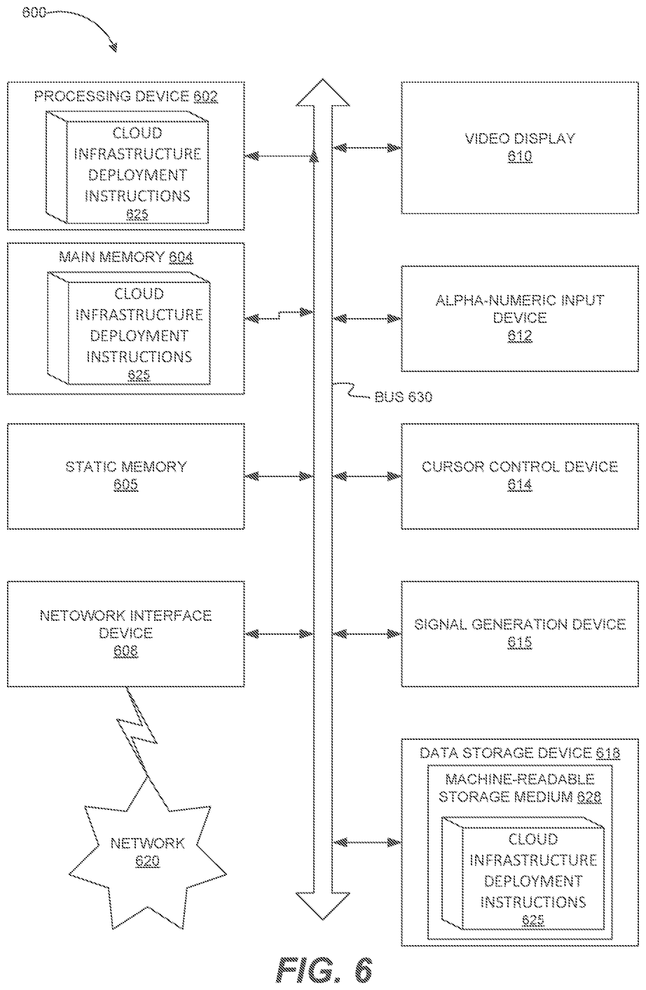

FIG. 6 illustrates a diagrammatic representation of a machine in the example form of a computer system 600 within which a set of instructions, for causing the machine to perform any one or more of the methodologies discussed herein for specifying a stream processing topology (dynamically creating topics, interacting with these topics, merging the topics, reading from the topics, and obtaining dynamic insights therefrom) via a client-side API without server-side support. The machine may perform a complete assessment of a disconnected environment to determine which prerequisite components (dependencies) necessary for the installation of cloud infrastructure are missing from the disconnected environment. The machine may import an offline bundle into the disconnected environment, wherein the offline bundle comprises an assessment playbook for performing the assessment. The machine may determine initial environment information, perform the assessment, and generate (using the assessment playbook) a report providing information about each of the missing prerequisite components and any additional environment information pertinent thereto. The machine may also generate, based on the report, an automation playbook for installing and deploying the missing prerequisite components. For each missing prerequisite component, the automation playbook may include a callout to an installation playbook corresponding to the missing prerequisite component. The offline bundle may include a set of installation playbooks, each installation playbook providing functionality to install and deploy a particular prerequisite component. It should be noted that the techniques described herein are not limited to installation of simple software on a single machine, but may apply to complex cloud infrastructures deployed across multiple machines. No third party tools are relied on for the assessment of the disconnected environment or the generation of the report or the automation playbook.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 600 may be representative of a server.

The exemplary computer system 600 includes a processing device 602 (which may be any appropriate processing device such as those manufactured by ARM™ corporation or Intel™ corporation), a main memory 604 (e.g., read-only memory (ROM), flash memory, dynamic random access memory (DRAM), a static memory 606 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses. In some embodiments, the computing device 600 may include one or more graphics processing units (GPUs) as many cloud workloads are dependent on GPUs, particularly for e.g., artificial intelligence (AI) workloads.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute cloud infrastructure deployment instructions 625, for performing the operations and steps discussed herein.

The data storage device 618 may include a machine-readable storage medium 628, on which is stored one or more sets of cloud infrastructure deployment instructions 625 (e.g., software) embodying any one or more of the methodologies of functions described herein. The cloud infrastructure deployment instructions 625 may also reside, completely or at least partially, within the main memory 604 or within the processing device 602 during execution thereof by the computer system 600; the main memory 604 and the processing device 602 also constituting machine-readable storage media. The cloud infrastructure deployment instructions 625 may further be transmitted or received over a network 620 via the network interface device 608.

The machine-readable storage medium 628 may also be used to store instructions to perform a method for deploying cloud infrastructure in a disconnected environment, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Example 1 is a method comprising: importing an offline bundle into a disconnected environment on which cloud software is to be installed, wherein the offline bundle comprises an assessment playbook; assessing, by a processing device, the disconnected environment using the assessment playbook to determine whether the disconnected environment includes each of a set of prerequisite components of the cloud software; generating a report indicating one or more of the set of prerequisite components that are missing from the disconnected environment; and generating an automation playbook based on the report, the automation playbook to install each of the one or more of the set of prerequisite components that are missing from the disconnected environment.

Example 2 is the method of example 1, wherein the assessment playbook comprises: a set of roles, each of the set of roles comprising code to determine whether a corresponding prerequisite component of the set of prerequisite components exists in the disconnected environment.

Example 3 is the method of example 1, wherein the set of prerequisite components comprises: a DHCP service, a DNS service, an image registry, an object storage, a package manager, an ignition webhost, a network load balancer, an application load balancer, and one or more required packages.

Example 4 is the method of example 1, wherein the offline bundle further comprises: a set of installation playbooks, wherein each of the set of installation playbooks installs and deploys a corresponding prerequisite component of the set of prerequisite components.

Example 5 is the method of example 4, wherein generating an automation playbook comprises: adding to the automation playbook, a call to each installation playbook corresponding to a prerequisite component that is missing from the disconnected environment.

Example 6 is the method of example 1, wherein the report comprises: for each of the one or more missing prerequisite components: a name of the prerequisite component; a short description of why the prerequisite component is required; and a reference to a uniform resource locator (URL) link to supporting documentation for the prerequisite component.

Example 7 is the method of example 1, further comprising: determining environment information of the disconnected environment, wherein the assessing the disconnected environment using the assessment playbook is based on the determined environment information of the disconnected environment.

Example 8 is a system comprising: a memory; and a processing device operatively coupled to the memory, the processing device to: assess a disconnected environment to determine whether the disconnected environment includes each of a set of prerequisite components for cloud software to be installed on the disconnected environment; generate a report indicating one or more of the set of prerequisite components that are missing from the disconnected environment and a location within an offline bundle where installation playbooks corresponding to each of the one or more missing prerequisite components is located; and generate an automation playbook based on the report, the automation playbook to install each of the one or more of the set of prerequisite components that are missing from the disconnected environment.

Example 9 is the system of example 8, wherein processing device is further to: import into the disconnected environment, an offline bundle comprising an assessment playbook, wherein the processing device assesses the disconnected environment using the assessment playbook.

Example 10 is the system of example 9, wherein the assessment playbook comprises: a set of roles, each of the set of roles comprising code to determine whether a corresponding prerequisite component of the set of prerequisite components exists in the disconnected environment.

Example 11 is the system of example 9, wherein the processing device is further to: determine environment information of the disconnected environment, wherein to assess the disconnected environment using the assessment playbook, the processing device assesses the disconnected environment using the assessment playbook based on the determined environment information of the disconnected environment.

Example 12 is the system of example 10, wherein the processing device is further to: determine additional environment information of the disconnected environment based on the report; and add the determined additional environment information to the report.

Example 13 is the system of example 8, wherein the offline bundle further comprises: a set of installation playbooks, wherein each of the set of installation playbooks installs and deploys a corresponding prerequisite component of the set of prerequisite components.

Example 14 is the system of example 13, wherein to generate an automation playbook, the processing device is to: add to the automation playbook, a call to each installation playbook corresponding to a prerequisite component that is missing from the disconnected environment.

Example 15 is a non-transitory computer-readable medium having instructions stored thereon which, when executed by a processing device, cause the processing device to: import an offline bundle into a disconnected environment on which cloud software is to be installed, wherein the offline bundle comprises an assessment playbook; assess, by the processing device, the disconnected environment using the assessment playbook to determine whether the disconnected environment includes each of a set of prerequisite components of the cloud software; generate a report indicating one or more of the set of prerequisite components that are missing from the disconnected environment; and generate an automation playbook based on the report, the automation playbook to install each of the one or more of the set of prerequisite components that are missing from the disconnected environment.

Example 16 is the non-transitory computer-readable medium of example 15, wherein the assessment playbook comprises: a set of roles, each of the set of roles comprising code to determine whether a corresponding prerequisite component of the set of prerequisite components exists in the disconnected environment.

Example 17 is the non-transitory computer-readable medium of example 15, wherein the set of prerequisite components comprises: a DHCP service, a DNS service, an image registry, an object storage, a package manager, an ignition webhost, a network load balancer, an application load balancer, and one or more required packages.

Example 18 is the non-transitory computer-readable medium of example 15, wherein the offline bundle further comprises: a set of installation playbooks, wherein each of the set of installation playbooks installs and deploys a corresponding prerequisite component of the set of prerequisite components.

Example 19 is the non-transitory computer-readable medium of example 18, wherein to generate an automation playbook, the processing device is to: add to the automation playbook, a call to each installation playbook corresponding to a prerequisite component that is missing from the disconnected environment.

Example 20 is the non-transitory computer-readable medium of example 15, wherein the report comprises: for each of the one or more missing prerequisite components: a name of the prerequisite component; a short description of why the prerequisite component is required; and a reference to a uniform resource locator (URL) link to supporting documentation for the prerequisite component.

Example 21 is the non-transitory computer-readable medium of example 15, wherein the processing device is further to: determine environment information of the disconnected environment, wherein the assessing the disconnected environment using the assessment playbook is based on the determined environment information of the disconnected environment.

Example 22 is a system comprising: a memory; and a processing device operatively coupled to the memory, the processing device to: import an offline bundle into a disconnected environment on which cloud software is to be installed, wherein the offline bundle comprises an assessment playbook; assess the disconnected environment using the assessment playbook to determine whether the disconnected environment includes each of a set of prerequisite components of the cloud software; generate a report indicating one or more of the set of prerequisite components that are missing from the disconnected environment; and generate an automation playbook based on the report, the automation playbook to install each of the one or more of the set of prerequisite components that are missing from the disconnected environment.

Example 23 is the system of example 22, wherein the assessment playbook comprises: a set of roles, each of the set of roles comprising code to determine whether a corresponding prerequisite component of the set of prerequisite components exists in the disconnected environment.

Example 24 is the system of example 22, wherein the set of prerequisite components comprises: a DHCP service, a DNS service, an image registry, an object storage, a package manager, an ignition webhost, a network load balancer, an application load balancer, and one or more required packages.

Example 25 is the system of example 22, wherein the offline bundle further comprises: a set of installation playbooks, wherein each of the set of installation playbooks installs and deploys a corresponding prerequisite component of the set of prerequisite components.

Example 26 is the system of example 25, wherein to generate an automation playbook, the processing device is to: add to the automation playbook, a call to each installation playbook corresponding to a prerequisite component that is missing from the disconnected environment.

Example 27 is the system of example 22, wherein the report comprises: for each of the one or more missing prerequisite components: a name of the prerequisite component; a short description of why the prerequisite component is required; and a reference to a uniform resource locator (URL) link to supporting documentation for the prerequisite component.

Example 28 is the system of example 22, wherein the processing device is further to: determine environment information of the disconnected environment, wherein to assess the disconnected environment using the assessment playbook, the processing device assesses the disconnected environment using the assessment playbook based on the determined environment information of the disconnected environment.

Example 29 is a method comprising: assessing a disconnected environment to determine whether the disconnected environment includes each of a set of prerequisite components for cloud software to be installed on the disconnected environment; generating a report indicating one or more of the set of prerequisite components that are missing from the disconnected environment and a location within an offline bundle where installation playbooks corresponding to each of the one or more missing prerequisite components is located; and generating an automation playbook based on the report, the automation playbook to install each of the one or more of the set of prerequisite components that are missing from the disconnected environment.

Example 30 is the method of example 29, further comprising: importing into the disconnected environment, an offline bundle comprising an assessment playbook, wherein the disconnected environment is assessed using the assessment playbook.

Example 31 is the method of example 30, wherein the assessment playbook comprises: a set of roles, each of the set of roles comprising code to determine whether a corresponding prerequisite component of the set of prerequisite components exists in the disconnected environment.

Example 32 is the method of example 31, further comprising: determining environment information of the disconnected environment, wherein to assess the disconnected environment using the assessment playbook, the processing device assesses the disconnected environment using the assessment playbook based on the determined environment information of the disconnected environment.

Example 33 is the method of example 31, further comprising: determining additional environment information of the disconnected environment based on the report; and add the determined additional environment information to the report.

Example 34 is the method of example 29, wherein the offline bundle further comprises: a set of installation playbooks, wherein each of the set of installation playbooks installs and deploys a corresponding prerequisite component of the set of prerequisite components.

Example 35 is the method of example 34, wherein generating the automation playbook comprises: adding to the automation playbook, a call to each installation playbook corresponding to a prerequisite component that is missing from the disconnected environment.

Example 36 is an apparatus comprising: means for importing an offline bundle into a disconnected environment on which cloud software is to be installed, wherein the offline bundle comprises an assessment playbook; means for assessing, by a processing device, the disconnected environment using the assessment playbook to determine whether the disconnected environment includes each of a set of prerequisite components of the cloud software; means for generating a report indicating one or more of the set of prerequisite components that are missing from the disconnected environment; and means for generating an automation playbook based on the report, the automation playbook to install each of the one or more of the set of prerequisite components that are missing from the disconnected environment.

Example 37 is the apparatus of example 36, wherein the assessment playbook comprises: a set of roles, each of the set of roles comprising code to determine whether a corresponding prerequisite component of the set of prerequisite components exists in the disconnected environment.

Example 38 is the apparatus of example 36, wherein the set of prerequisite components comprises: a DHCP service, a DNS service, an image registry, an object storage, a package manager, an ignition webhost, a network load balancer, an application load balancer, and one or more required packages.

Example 39 is the apparatus of example 36, wherein the offline bundle further comprises: a set of installation playbooks, wherein each of the set of installation playbooks installs and deploys a corresponding prerequisite component of the set of prerequisite components.

Example 40 is the apparatus of example 39, wherein the means for generating an automation playbook comprises: means for adding to the automation playbook, a call to each installation playbook corresponding to a prerequisite component that is missing from the disconnected environment.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
importing an offline bundle into a disconnected environment on which cloud software is to be installed, wherein the offline bundle comprises an assessment playbook;
assessing, by a processing device, the disconnected environment using the assessment playbook to determine whether the disconnected environment includes each of a set of prerequisite components of the cloud software;
generating a report indicating one or more of the set of prerequisite components that are missing from the disconnected environment; and
generating an automation playbook based on the report, the automation playbook to install each of the one or more of the set of prerequisite components that are missing from the disconnected environment.

2. The method of claim 1, wherein the assessment playbook comprises:
a set of roles, each of the set of roles comprising code to determine whether a corresponding prerequisite component of the set of prerequisite components exists in the disconnected environment.

3. The method of claim 1, wherein the set of prerequisite components comprises:
a dynamic host configuration protocol (DHCP) service, a domain name system (DNS) service, an image registry, an object storage, a package manager, an ignition webhost, a network load balancer, an application load balancer, and one or more required packages.

4. The method of claim 1, wherein the offline bundle further comprises:
a set of installation playbooks, wherein each of the set of installation playbooks installs and deploys a corresponding prerequisite component of the set of prerequisite components.

5. The method of claim 4, wherein generating an automation playbook comprises:
adding to the automation playbook, a call to each installation playbook corresponding to a prerequisite component that is missing from the disconnected environment.

6. The method of claim 1, wherein the report comprises:
for each of the one or more missing prerequisite components:
a name of the prerequisite component;
a short description of why the prerequisite component is required; and
a reference to a uniform resource locator (URL) link to supporting documentation for the prerequisite component.

7. The method of claim 1, further comprising:
determining environment information of the disconnected environment, wherein the assessing the disconnected environment using the assessment playbook is based on the determined environment information of the disconnected environment.

8. A system comprising:
a memory; and
a processing device operatively coupled to the memory, the processing device to:
assess a disconnected environment to determine whether the disconnected environment includes each of a set of prerequisite components for cloud software to be installed on the disconnected environment;
generate a report indicating one or more of the set of prerequisite components that are missing from the disconnected environment and a location within an offline bundle where installation playbooks corresponding to each of the one or more missing prerequisite components is located; and
generate an automation playbook based on the report, the automation playbook to install each of the one or more of the set of prerequisite components that are missing from the disconnected environment.

9. The system of claim 8, wherein processing device is further to:
import into the disconnected environment, an offline bundle comprising an assessment playbook, wherein the processing device assesses the disconnected environment using the assessment playbook.

10. The system of claim 9, wherein the assessment playbook comprises:
a set of roles, each of the set of roles comprising code to determine whether a corresponding prerequisite component of the set of prerequisite components exists in the disconnected environment.

11. The system of claim 9, wherein the processing device is further to:
determine environment information of the disconnected environment, wherein to assess the disconnected environment using the assessment playbook, the processing device assesses the disconnected environment using the assessment playbook based on the determined environment information of the disconnected environment.

12. The system of claim 10, wherein the processing device is further to:
determine additional environment information of the disconnected environment based on the report; and
add the determined additional environment information to the report.

13. The system of claim 8, wherein the offline bundle further comprises:
a set of installation playbooks, wherein each of the set of installation playbooks installs and deploys a corresponding prerequisite component of the set of prerequisite components.

14. The system of claim 13, wherein to generate an automation playbook, the processing device is to:
add to the automation playbook, a call to each installation playbook corresponding to a prerequisite component that is missing from the disconnected environment.

15. A non-transitory computer-readable medium having instructions stored thereon which, when executed by a processing device, cause the processing device to:
import an offline bundle into a disconnected environment on which cloud software is to be installed, wherein the offline bundle comprises an assessment playbook;
assess, by the processing device, the disconnected environment using the assessment playbook to determine whether the disconnected environment includes each of a set of prerequisite components of the cloud software;
generate a report indicating one or more of the set of prerequisite components that are missing from the disconnected environment; and
generate an automation playbook based on the report, the automation playbook to install each of the one or more of the set of prerequisite components that are missing from the disconnected environment.

16. The non-transitory computer-readable medium of claim 15, wherein the assessment playbook comprises:
a set of roles, each of the set of roles comprising code to determine whether a corresponding prerequisite component of the set of prerequisite components exists in the disconnected environment.

17. The non-transitory computer-readable medium of claim 15, wherein the set of prerequisite components comprises:
a dynamic host configuration protocol (DHCP) service, a domain name system (DNS) service, an image registry, an object storage, a package manager, an ignition webhost, a network load balancer, an application load balancer, and one or more required packages.

18. The non-transitory computer-readable medium of claim 15, wherein the offline bundle further comprises:
a set of installation playbooks, wherein each of the set of installation playbooks installs and deploys a corresponding prerequisite component of the set of prerequisite components.

19. The non-transitory computer-readable medium of claim 18, wherein to generate an automation playbook, the processing device is to:
add to the automation playbook, a call to each installation playbook corresponding to a prerequisite component that is missing from the disconnected environment.

20. The non-transitory computer-readable medium of claim 15, wherein the report comprises:
for each of the one or more missing prerequisite components:
a name of the prerequisite component;
a short description of why the prerequisite component is required; and
a reference to a uniform resource locator (URL) link to supporting documentation for the prerequisite component.
